(19) United States
(12) Patent Application Publication
(10) Pub. No.: US 2024/0219873 A1
(43) Pub. Date: Jul. 4, 2024

(54) APPARATUS CONTROL DEVICE AND APPARATUS CONTROL METHOD

(71) Applicant: Mitsubishi Electric Corporation, Tokyo (JP)

(72) Inventors: Toshisada MARIYAMA, Tokyo (JP); Hiroaki HOKARI, Tokyo (JP); Nobuyuki YOSHIKAWA, Tokyo (JP); Genta YOSHIMURA, Tokyo (JP); Yoshikuni MIYATA, Tokyo (JP); Yusuke YOKOSUKA, Tokyo (JP)

(73) Assignee: Mitsubishi Electric Corporation, Tokyo (JP)

(21) Appl. No.: 18/610,055

(22) Filed: Mar. 19, 2024

Related U.S. Application Data
(63) Continuation of application No. PCT/JP2021/045729, filed on Dec. 13, 2021.

(51) Int. Cl. G05B 13/04; G05B 13/02

(52) U.S. Cl. CPC G05B 13/048; G05B 13/0265

(57) ABSTRACT

An apparatus control device includes an observed value acquiring unit that acquires, from a sensor that observes an environment in which a control target apparatus is installed, an observed value of the environment, an observation predicted value acquiring unit that gives an observed value acquired to a first learning model and acquires an observation predicted value that is a future observed value from the sensor from the first learning model, and an unobservable value acquiring unit that gives an observed value acquired to a second learning model and acquires an unobservable value that is a value not directly observed by the sensor from the second learning model. In addition, the apparatus control device includes a control value calculating unit that calculates a control value of the control target apparatus using the observed value acquired, the observation predicted value acquired, and the unobservable value acquired.

### CROSS-REFERENCE TO RELATED APPLICATION

This application is a Continuation of PCT International Application No. PCT/JP2021/045729, filed on Dec. 13, 2021, which is hereby expressly incorporated by reference into the present application.

### TECHNICAL FIELD

The present disclosure relates to an apparatus control device and an apparatus control method.

### BACKGROUND ART

There is an apparatus control device that calculates a control value of a control target apparatus. For example, Patent Literature 1 discloses an air conditioning control device that acquires a control value of an air conditioner serving as a control target apparatus.

The air conditioning control device includes an acquisition unit that acquires, from a sensor that observes an environment in which the air conditioning control device is installed, an observed value of the environment and a control-content determination unit that gives the observed value acquired by the acquisition unit to a learning model and acquires a control value of the air conditioner from the learning model.

### CITATION LIST

### Patent Literatures

Patent Literature 1: JP 2021-156565 A

### SUMMARY OF INVENTION

### Technical Problem

As information to be considered in order to more appropriately control a control target apparatus, in addition to an observable value that can be observed by a sensor, an unobservable value that cannot be directly observed by the sensor may be required.

For example, in the air conditioning control device disclosed in Patent Literature 1, an observable value such as a temperature that can be observed by a sensor is considered, but an unobservable value such as a thermal load is not considered. In a case where the thermal load or the like is not considered, it is difficult to correctly estimate how the environment changes depending on the output of an air conditioner, so that appropriate air conditioning control cannot be executed.

A conventional apparatus control device like the air conditioning control device disclosed in Patent Literature 1 has a problem that a control value is not calculated in consideration of an unobservable value.

The present disclosure has been made to solve the above problems, and an object thereof is to obtain an apparatus control device and an apparatus control method capable of acquiring a control value that changes depending on an unobservable value that is a value not directly observed by a sensor.

### Solution to Problem

An apparatus control device according to the present disclosure includes a processor; and a memory storing a program, upon executed by the processor, to perform a process: to acquire, from a sensor to observe an environment in which a control target apparatus is installed, an observed value of the environment; to give an observed value acquired to a first learning model and acquire an observation predicted value that is a future observed value from the sensor from the first learning model; to give an observed value acquired to a second learning model and acquire an unobservable value that is a value not directly observed by the sensor from the second learning model; and to calculate a control value of the control target apparatus using an observed value acquired, an observation predicted value acquired, and an unobservable value acquired, wherein the process includes to, by substituting an observed value acquired, an observation predicted value acquired, and an unobservable value acquired into each of equations of state in each of the plurality of control methods, calculate a control value for each of a plurality of control methods as a control value of the control target apparatus, and to select a control value for any one of the plurality of control methods among control values for the plurality of control methods calculated.

### Advantageous Effects of Invention

According to the present disclosure, it is possible to acquire a control value that changes depending on the unobservable value that is a value not directly observed by the sensor.

### BRIEF DESCRIPTION OF DRAWINGS

FIG. 1 is a configuration diagram illustrating an apparatus control system including an apparatus control device 3 according to a first embodiment.

FIG. 2 is a hardware configuration diagram illustrating hardware of the apparatus control device 3 according to the first embodiment.

FIG. 3 is a hardware configuration diagram of a computer in a case where the apparatus control device 3 is implemented by software, firmware, or the like.

FIG. 4 is a flowchart illustrating an apparatus control method that is a processing procedure performed by the apparatus control device 3.

FIG. 5 is a flowchart illustrating processing contents of a state prediction unit 15.

FIG. 6 is a configuration diagram illustrating an apparatus control system including an apparatus control device 3 according to a second embodiment.

FIG. 7 is a hardware configuration diagram illustrating hardware of the apparatus control device 3 according to the second embodiment.

FIG. 8 is a configuration diagram illustrating an apparatus control system including an apparatus control device 3 according to a third embodiment.

FIG. 9 is a hardware configuration diagram illustrating hardware of the apparatus control device 3 according to the third embodiment.

FIG. 10 is an explanatory diagram illustrating an observation predicted value X^{j}(t) and an observed value X^{j}(t) acquired at a time (t−1).

### DESCRIPTION OF EMBODIMENTS

Hereinafter, in order to describe the present disclosure in more detail, embodiments for carrying out the present disclosure will be described with reference to the accompanying drawings.

### First Embodiment

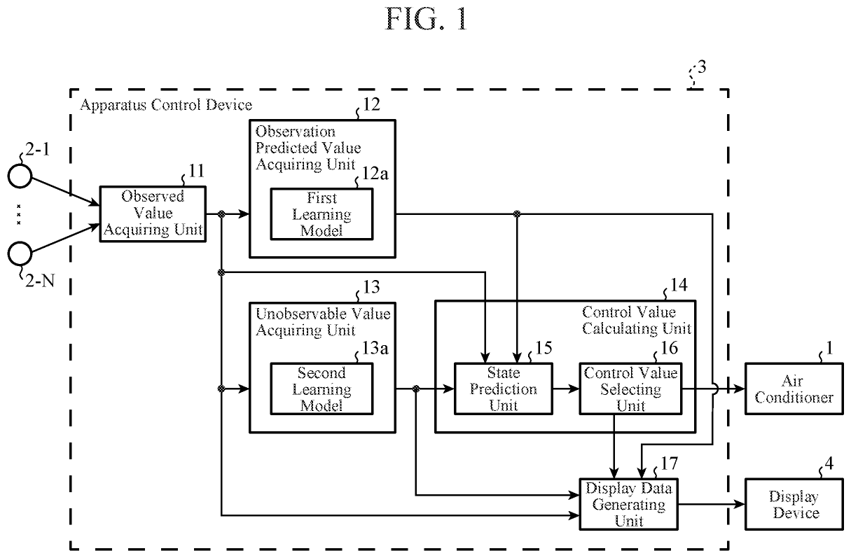

FIG. 1 is a configuration diagram illustrating an apparatus control system including an apparatus control device 3 according to a first embodiment.

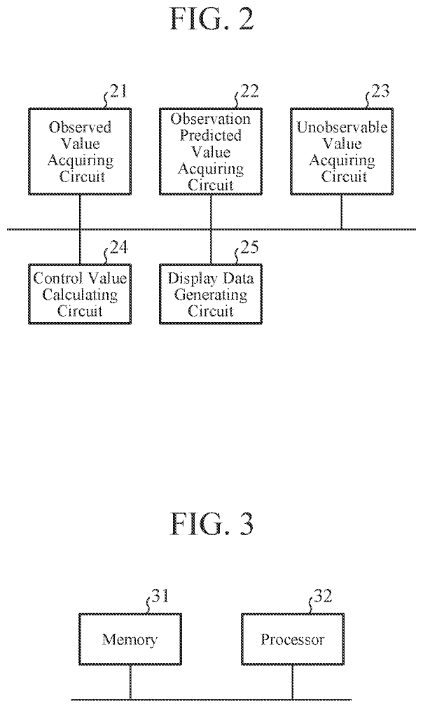

FIG. 2 is a hardware configuration diagram illustrating hardware of the apparatus control device 3 according to the first embodiment.

The apparatus control system illustrated in FIG. 1 is a system including the apparatus control device 3 that acquires a control value of an air conditioner 1 serving as a control target apparatus and controls the air conditioner 1 based on the control value. In the apparatus control system illustrated in FIG. 1, the air conditioner 1 is a control target apparatus. However, this is merely an example, and for example, a robot, a boiler, a servo system, an infrastructure control apparatus, a pump control apparatus, a building control apparatus, or an elevator may be the control target apparatus.

The apparatus control system illustrated in FIG. 1 includes the air conditioner 1, N (N is an integer equal to or more than one) sensors 2-1 to 2-N, the apparatus control device 3, and a display device 4.

The sensor 2-n (n=1, . . . , N) observes an environment in which the air conditioner 1 is installed, and outputs an observed value of the environment to the apparatus control device 3.

Examples of the sensor 2-n include a room temperature sensor that observes the indoor temperature of a room in which the air conditioner 1 is installed, an outside air temperature sensor that observes the outside air temperature of the room, a humidity sensor that observes the humidity of the room, a solar radiation sensor that observes the amount of solar radiation to the room, and a human sensor that observes the number of people present in the room.

The apparatus control device 3 includes an observed value acquiring unit 11, an observation predicted value acquiring unit 12, an unobservable value acquiring unit 13, a control value calculating unit 14, and a display data generating unit 17.

The display device 4 includes a display.

The display device 4 displays the control value and the like of the air conditioner 1 on the display based on display data output from the apparatus control device 3.

The observed value acquiring unit 11 is implemented by, for example, an observed value acquiring circuit 21 illustrated in FIG. 2.

The observed value acquiring unit 11 acquires an observed value of an environment from the sensor 2-n (n=1, . . . , N).

The observed value acquiring unit 11 outputs the observed value of the environment to each of the observation predicted value acquiring unit 12, the unobservable value acquiring unit 13, the control value calculating unit 14, and the display data generating unit 17.

The observation predicted value acquiring unit 12 is implemented by, for example, an observation predicted value acquiring circuit 22 illustrated in FIG. 2.

An internal memory of the observation predicted value acquiring unit 12 stores a first learning model 12a.

The first learning model 12a is implemented by, for example, a neural network model or a deep learning model.

In the first learning model 12a, at the time of learning, the observed value of the environment from the sensor 2-n (n=1, . . . , N) is given as input data, and an observation predicted value that is a future observed value from the sensor 2-n is given as training data. The first learning model 12a outputs an observation predicted value corresponding to the input data at the time of inference by learning the observation predicted value at the time of learning.

In the apparatus control device 3 illustrated in FIG. 1, the first learning model 12a is stored in the internal memory of the observation predicted value acquiring unit 12. However, this is merely an example, and the first learning model 12a may be stored in a storage device outside the apparatus control device 3.

The observation predicted value acquiring unit 12 gives the observed value acquired by the observed value acquiring unit 11 to the first learning model 12a, and acquires the observation predicted value from the first learning model 12a.

The observation predicted value acquiring unit 12 outputs the observation predicted value acquired from the first learning model 12a to each of the control value calculating unit 14 and the display data generating unit 17.

The unobservable value acquiring unit 13 is implemented by, for example, an unobservable value acquiring circuit 23 illustrated in FIG. 2.

An internal memory of the unobservable value acquiring unit 13 stores a second learning model 13a.

The second learning model 13a is implemented by, for example, a neural network model or a deep learning model.

In the second learning model 13a, at the time of learning, the observed value of the environment from the sensor 2-n (n=1, . . . , N) is given as input data, and an unobservable value that is a value not directly observed by the sensor 2-n is given as training data. The second learning model 13a outputs an unobservable value corresponding to the input data at the time of inference by learning the unobservable value at the time of learning.

In the apparatus control device 3 illustrated in FIG. 1, the second learning model 13a is stored in the internal memory of the unobservable value acquiring unit 13. However, this is merely an example, and the second learning model 13a may be stored in a storage device outside the apparatus control device 3.

The unobservable value acquiring unit 13 gives the observed value acquired by the observed value acquiring unit 11 to the second learning model 13a, and acquires the unobservable value that is a value not directly observed by the sensor 2-n from the second learning model 13a.

The unobservable value acquiring unit 13 outputs the unobservable value acquired from the second learning model 13a to each of the control value calculating unit 14 and the display data generating unit 17.

The control value calculating unit 14 is implemented by, for example, a control value calculating circuit 24 illustrated in FIG. 2.

The control value calculating unit 14 includes a state prediction unit 15 and a control value selecting unit 16.

The control value calculating unit 14 acquires an observed value from the observed value acquiring unit 11, acquires an observation predicted value from the observation predicted value acquiring unit 12, and acquires an unobservable value from the unobservable value acquiring unit 13.

The control value calculating unit 14 calculates the control value of the air conditioner 1 using the observed value acquired by the observed value acquiring unit 11, the observation predicted value acquired by the observation predicted value acquiring unit 12, and the unobservable value acquired by the unobservable value acquiring unit 13.

The control value calculating unit 14 outputs the control value to each of the air conditioner 1 and the display data generating unit 17.

The state prediction unit 15 substitutes the observed value acquired by the observed value acquiring unit 11, the observation predicted value acquired by the observation predicted value acquiring unit 12, and the unobservable value acquired by the unobservable value acquiring unit 13 into an equation of state, and obtains the solution of the equation of state as the control value of the air conditioner 1.

In addition, when each equation of state in each of a plurality of control methods is prepared as the equation of state, the state prediction unit 15 substitutes the observed value, the observation predicted value, and the unobservable value into each equation of state, thereby calculating a control value for each control method.

The control value selecting unit 16 selects a control value for any one control method among control values for a plurality of control methods.

The control value selecting unit 16 outputs the selected control value to each of the air conditioner 1 and the display data generating unit 17.

The display data generating unit 17 is implemented by, for example, a display data generating circuit 25 illustrated in FIG. 2.

The display data generating unit 17 generates display data for displaying one or more of the unobservable value acquired by the unobservable value acquiring unit 13 and the control value calculated by the control value calculating unit 14, and outputs the display data to the display device 4.

In addition, the display data generating unit 17 generates display data for displaying one or more of the observed value acquired by the observed value acquiring unit 11 and the observation predicted value acquired by the observation predicted value acquiring unit 12, and outputs the display data to the display device 4.

In FIG. 1, it is assumed that each of the observed value acquiring unit 11, the observation predicted value acquiring unit 12, the unobservable value acquiring unit 13, the control value calculating unit 14, and the display data generating unit 17, which are components of the apparatus control device 3, is implemented by dedicated hardware illustrated in FIG. 2. That is, it is assumed that the apparatus control device 3 is implemented by the observed value acquiring circuit 21, the observation predicted value acquiring circuit 22, the unobservable value acquiring circuit 23, the control value calculating circuit 24, and the display data generating circuit 25.

Each of the observed value acquiring circuit 21, the observation predicted value acquiring circuit 22, the unobservable value acquiring circuit 23, the control value calculating circuit 24, and the display data generating circuit 25 corresponds to, for example, a single circuit, a composite circuit, a programmed processor, a parallel programmed processor, an application specific integrated circuit (ASIC), a field-programmable gate array (FPGA), or a combination thereof.

The components of the apparatus control device 3 are not limited to those implemented by dedicated hardware, and the apparatus control device 3 may be implemented by software, firmware, or a combination of software and firmware.

The software or firmware is stored in a memory of a computer as a program. The computer means hardware that executes the program, and corresponds to, for example, a central processing unit (CPU), a central processing device, a processing device, an arithmetic device, a microprocessor, a microcomputer, a processor, or a digital signal processor (DSP).

FIG. 3 is a hardware configuration diagram of a computer in a case where the apparatus control device 3 is implemented by software, firmware, or the like.

In a case where the apparatus control device 3 is implemented by software, firmware, or the like, a program for causing a computer to execute each processing procedure in each of the observed value acquiring unit 11, the observation predicted value acquiring unit 12, the unobservable value acquiring unit 13, the control value calculating unit 14, and the display data generating unit 17 is stored in a memory 31. Then, a processor 32 of the computer executes the program stored in the memory 31.

In addition, FIG. 2 illustrates an example in which each of the components of the apparatus control device 3 is implemented by dedicated hardware, and FIG. 3 illustrates an example in which the apparatus control device 3 is implemented by software, firmware, or the like. However, this is merely an example, and some components in the apparatus control device 3 may be implemented by dedicated hardware, and the remaining components may be implemented by software, firmware, or the like.

Next, an operation of the apparatus control system illustrated in FIG. 1 will be described.

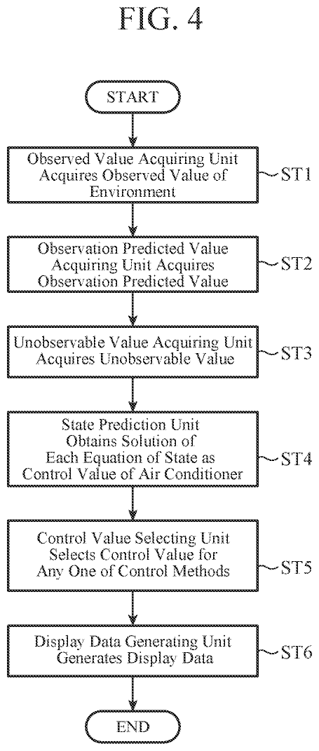

FIG. 4 is a flowchart illustrating an apparatus control method that is a processing procedure performed by the apparatus control device 3.

In the apparatus control system illustrated in FIG. 1, for convenience of explanation, it is assumed that the sensors 2-1 to 2-N include J room temperature sensors that observe the room temperature of a room, which is the environment in which the air conditioner 1 is installed, and K human sensors that observe the number of people present in the room. Each of J and K is an integer equal to or more than one and equal to or less than N, and (J+K)≤N.

J room temperature sensors are individually distinguished by 2′-1 to 2′-J, and K human sensors are individually distinguished by 2″-1 to 2″-K.

The observed value of room temperature observed by the room temperature sensor 2′-j (j=1, . . . , J) is X^{j}(t), and the observed value of the number of people observed by the human sensor 2″-k (k=1, . . . , K) is Y^{k}(t). t is a current time, and t+q is a future time. q=1, . . . , Q, and Q is an integer equal to or more than one.

The room temperature sensor 2′-j (j=1, . . . , J) outputs the observed value X^{j}(t) of the room temperature to the apparatus control device 3.

The human sensor 2″-k (k=1, . . . , K) outputs the observed value Y^{k}(t) of the number of people to the apparatus control device 3.

In the apparatus control system illustrated in FIG. 1, the room temperature sensor 2′-j and the human sensor 2″-k are sensors 2-n that observe the environment in which the air conditioner 1 is installed. However, this is merely an example, and the sensor 2-n that observes the environment in which the air conditioner 1 is installed may be, for example, an outside air temperature sensor that observes an outside air temperature outside the room that is the environment in which the air conditioner 1 is installed, a humidity sensor that observes the humidity of the room, a daily illuminance sensor that observes the daily illuminance to the room, or a sensor that acquires a weather forecast value of an area including the environment.

The observed value acquiring unit 11 of the apparatus control device 3 acquires the observed value X^{j}(t) of the room temperature as the observed value of the environment from the room temperature sensor 2′-j (j=1, . . . , J) (step ST1 in FIG. 4).

In addition, the observed value acquiring unit 11 acquires the observed value Y^{k}(t) of the number of people as the observed value of the environment from the human sensor 2″-k (k=1, . . . , K) (step ST1 in FIG. 4).

The observed value acquiring unit 11 outputs the observed value X^{j}(t) of the room temperature and the observed value Y^{k}(t) of the number of people to each of the observation predicted value acquiring unit 12, the unobservable value acquiring unit 13, the control value calculating unit 14, and the display data generating unit 17.

The observation predicted value acquiring unit 12 acquires each of the observed value X^{j}(t) (j=1, . . . , J) of the room temperature and the observed value Y^{k}(t) (k=1, . . . , K) of the number of people from the observed value acquiring unit 11.

At the time of learning, the first learning model 12a is assumed to be given, as the input data, a set temperature T_{SET} of the air conditioner 1 in addition to the observed value X^{j}(t) of the room temperature and the observed value Y^{k}(t) of the number of people, for example. Furthermore, it is assumed that a future observed value X^{j}(t+q) (q=1, . . . , Q) of the room temperature is given to the first learning model 12a as the training data. In this case, the first learning model 12a learns the future observed value X^{j}(t+q) of the room temperature.

The future observed value X^{j}(t+q) of the room temperature, which is the training data, is simulated by a simulator (not illustrated) on the basis of the observed value X^{j}(t) of the room temperature, the observed value Y^{k}(t) of the number of people, and the set temperature T_{SET}, for example. If the observed value Y^{k}(t) of the number of people is known, it is possible to estimate the total approximate value of the amount of heat output from one or more persons present in the room. In addition, if the observed value X^{j}(t) of the room temperature and the set temperature T_{SET} are known, it is possible to estimate the operation rate that is the workload of the air conditioner 1. Therefore, if the observed value X^{j}(t) of the room temperature, the observed value Y^{k}(t) of the number of people, and the set temperature T_{SET} are given, the simulator can simulate the future observed value X^{j}(t+q) of the room temperature. Here, if the set temperature T_{SET} is a fixed temperature fixed to, for example, 23 degrees, the simulator can simulate the future observed value X^{j}(t+q) of the room temperature using the fixed temperature instead of the set temperature T_{SET}. In this case, even if the set temperature T_{SET} is not given to the first learning model 12a at the time of learning, the first learning model 12a can learn the future observed value X^{j}(t+q) of the room temperature.

Here, the simulator simulates the future observed value X^{j}(t+q) of the room temperature using the observed value X^{j}(t) of the room temperature, the observed value Y^{k}(t) of the number of people, and the set temperature T_{SET}. However, this is merely an example, and even if the simulator uses the observed value of the daily illuminance from the daily illuminance sensor instead of the observed value Y^{k}(t) of the number of people, it is possible to simulate the future observed value X^{j}(t+q) of the room temperature. In this case, the first learning model 12a learns the future observed value X^{j}(t+q) of the room temperature if, at the time of learning, the observed value X^{j}(t) of the room temperature, the observed value of the daily illuminance, and the set temperature T_{SET} are given as the input data and the future observed value X^{j}(t+q) of the room temperature is given as the training data.

In addition, the simulator can simulate the future observed value X^{j}(t+q) of the room temperature using, for example, the observed value of the daily illuminance in addition to the observed value X^{j}(t) of the room temperature, the observed value Y^{k}(t) of the number of people, and the set temperature T_{SET}. In general, the simulation accuracy of the simulator improves as the number of types of input data increases. In this case, the first learning model 12a learns the future observed value X^{j}(t+q) of the room temperature if, at the time of learning, the observed value X^{j}(t) of the room temperature, the observed value Y^{k}(t) of the number of people, the observed value of the daily illuminance, and the set temperature T_{SET} are given as the input data and the future observed value X^{j}(t+q) of the room temperature is given as the training data.

The simulator may simulate the future observed value of humidity using, for example, the observed value of humidity from the humidity sensor and the observed value Y^{k}(t) of the number of people, instead of the observed value X^{j}(t) of the room temperature. In this case, the first learning model 12a learns the future observed value of humidity if, at the time of learning, the observed value of humidity from the humidity sensor and the observed value Y^{k}(t) of the number of people are given as the input data and the future observed value of humidity is given as the training data. If the first learning model 12a learns the future observed value of humidity, the future observed value of humidity can be output at the time of inference.

If the input data at the time of learning includes, for example, the observed value X^{j}(t) of the room temperature and the observed value Y^{k}(t) of the number of people, the observation predicted value acquiring unit 12 gives the observed value X^{j}(t) of the room temperature and the observed value Y^{k}(t) of the number of people to the first learning model 12a at the time of inference.

If the input data at the time of learning includes, for example, the observed value X^{j}(t) of the room temperature, the observed value Y^{k}(t) of the number of people, and the set temperature T_{SET}, the observation predicted value acquiring unit 12 gives the observed value X^{j}(t) of the room temperature, the observed value Y^{k}(t) of the number of people, and the set temperature T_{SET} to the first learning model 12a at the time of inference.

The observation predicted value acquiring unit 12 acquires, from the first learning model 12a, an observation predicted value X^{j}(t+q) that is a future observed value X^{j}(t+q) (q=1, . . . , Q) of the room temperature as an inference result (step ST2 in FIG. 4).

The observation predicted value acquiring unit 12 outputs the observation predicted value X^{j}(t+q) to each of the control value calculating unit 14 and the display data generating unit 17.

The unobservable value acquiring unit 13 acquires the observed value Y^{k}(t) (k=1, . . . , K) of the number of people from the observed value acquiring unit 11.

It is assumed that, at the time of learning, each of the observed value Y^{k}(t) of the number of people and history data is given to the second learning model 13a as the input data. In addition, it is assumed that the current unobservable value Z^{m}(t) and the future unobservable value Z^{m}(t+q) (q=1, . . . , Q) are given to the second learning model 13a as the training data. m=1, . . . , M, and M is an integer equal to or more than one. In this case, the second learning model 13a learns each of the current unobservable value Z^{m}(t) and the future unobservable value Z^{m}(t+q). The history data is data indicating a change in the number of people in the past with the lapse of time. Furthermore, the history data is obtained by recording the observed value of the number of people in the past output from the observed value acquiring unit 11.

Each of the current unobservable value Z^{m}(t) and the future unobservable value Z^{m}(t+q), which are the training data, is simulated by a simulator (not illustrated) on the basis of the observed value Y^{k}(t) of the number of people and the history data. If the observed value Y^{k}(t) of the number of people is known, it is possible to estimate the total approximate value of the amount of heat output from one or more persons present in the room. In addition, if the history data can be obtained, the tendency of the change in the number of people with the lapse of time can be known, thus it is possible to estimate the tendency of the change in the thermal load. Therefore, in a case where the unobservable value is a thermal load, the simulator can simulate each of the current unobservable value Z^{m}(t) and the future unobservable value Z^{m}(t+q) (q=1, . . . , Q) if the observed value Y^{k}(t) of the number of people and the history data are given.

Here, the simulator simulates each of the current unobservable value Z^{m}(t) and the future unobservable value Z^{m}(t+q) using the observed value Y^{k}(t) of the number of people and the history data. However, this is merely an example, and the simulator may simulate each of the current unobservable value Z^{m}(t) and the future unobservable value Z^{m}(t+q) using the observed value Y^{k}(t) of the number of people and the past observed value Y^{k}(t−1) of the number of people.

In this case, the second learning model 13a learns each of the current unobservable value Z^{m}(t) and the future unobservable value Z^{m}(t+q) if, at the time of learning, the observed value Y^{k}(t) of the number of people and the past observed value Y^{k}(t−1) of the number of people are given as the input data and the current unobservable value Z^{m}(t) and the future unobservable value Z^{m}(t+q) are given as the training data.

In addition, the simulator can simulate each of the current unobservable value Z^{m}(t) and the future unobservable value Z^{m}(t+q) using, for example, the observed value of the daily illuminance in addition to the observed value Y^{k}(t) of the number of people and the past observed value Y^{k}(t−1) of the number of people. In general, the simulation accuracy of the simulator improves as the number of types of input data increases. In this case, the second learning model 13a learns each of the current unobservable value Z^{m}(t) and the future unobservable value Z^{m}(t+q) if, at the time of learning, the observed value Y^{k}(t) of the number of people, the past observed value Y^{k}(t−1) of the number of people, and the observed value of the daily illuminance are given as the input data and the current unobservable value Z^{m}(t) and the future unobservable value Z^{m}(t+q) are given as the training data.

In the apparatus control system illustrated in FIG. 1, assuming that the unobservable value is a thermal load, the second learning model 13a learns each of the current unobservable value Z^{m}(t) and the future unobservable value Z^{m}(t+q). However, this is merely an example, and the second learning model 13a may learn each of the current unobservable value and the future unobservable value other than the thermal load.

Examples of the unobservable value other than the thermal load include convection in a room that is an environment in which the air conditioner 1 is installed.

For example, if the observed value X^{j}(t) of the room temperature, the blowing direction of the air conditioner 1, and layout data are used, the simulator can simulate the convection in the room as the unobservable value. The layout data is data indicating the arrangement of furniture or the like installed in a room. In this case, if, at the time of learning, the observed value X^{j}(t) of the room temperature, the blowing direction of the air conditioner 1, and the layout data are given as the input data, and the current convection and the future convection are given as the training data, the second learning model 13a determines that the unobservable value is the convection, and learns each of the current unobservable value Z^{m}(t) and the future unobservable value Z^{m}(t+q).

For example, if the blowing direction of the air conditioner 1 and the layout data are constant, the second learning model 13a can learn each of the current unobservable value Z^{m}(t) and the future unobservable value Z^{m}(t+q) if only the observed value X^{j}(t) of the room temperature is given as the input data and the current convection and the future convection are given as the training data.

In addition, examples of the unobservable value other than the thermal load include the opening and closing degree of a valve under a situation in which an opening degree sensor is not installed, the amount of microorganisms under a situation in which a microorganism detection sensor is not installed, and the number of people under a situation in which a human sensor is not installed.

If the input data at the time of learning includes, for example, the observed value Y^{k}(t) of the number of people and the past observed value Y^{k}(t−1) of the number of people, the unobservable value acquiring unit 13 gives the observed value Y^{k}(t) of the number of people and the past observed value Y^{k}(t−1) of the number of people to the second learning model 13a at the time of inference.

If the input data at the time of learning includes, for example, the observed value Y^{k}(t) of the number of people and the history data, the unobservable value acquiring unit 13 gives the observed value Y^{k}(t) of the number of people and the history data to the second learning model 13a at the time of inference.

The unobservable value acquiring unit 13 acquires, from the second learning model 13a, each of the current unobservable value Z^{m}(t) and the future unobservable value Z^{m}(t+q) as an inference result (step ST3 in FIG. 4).

The unobservable value acquiring unit 13 outputs the current unobservable value Z^{m}(t) and the future unobservable value Z^{m}(t+q) to each of the control value calculating unit 14 and the display data generating unit 17.

The state prediction unit 15 of the control value calculating unit 14 acquires the observed value X^{j}(t) of the room temperature and the observed value Y^{k}(t) of the number of people from the observed value acquiring unit 11.

In addition, the state prediction unit 15 acquires the observation predicted value X^{j}(t+q) (q=1, . . . , Q) from the observation predicted value acquiring unit 12.

The state prediction unit 15 further acquires, from the unobservable value acquiring unit 13, each of the current unobservable value Z^{m}(t) and the future unobservable value Z^{m}(t+q).

The state prediction unit 15 acquires equations of state in C control methods from the internal memory. C is an integer equal to or larger than two. Examples of the control method include proportional integral differential (PID) control, proportional control, open sound control (OSC), model predictive control (MPC), and control in deep learning.

The following equation (1) shows an example of the equation of state.

$$\frac{d {X}^{j} ( t )}{dt} = {\sum }_{j = 1}^{J} {P}_{1 j} {X}^{j} ( t ) + {\sum }_{k = 1}^{K} {P}_{2 k} {Y}^{k} ( t ) + {\sum }_{g = 1}^{G} {P}_{3 g} {W}^{g} ( t ) + {Z}^{m} ( t ) \qquad ( 1 )$$

In Equation (1), W^{g}(t) is a control value of the air conditioner 1. g=1, . . . , G, and G is an integer equal to or more than one.

Each of P₁ⱼ, P₂ₖ, and P_{3g} is a parameter of the apparatus control system and is a default value.

When calculating G current control values W^{g}(t) (g=1, . . . , G) in the air conditioner 1, the state prediction unit 15 substitutes the observed value X^{j}(t) of the room temperature, the observed value Y^{k}(t) of the number of people, the observation predicted value X^{j}(t+1), and the unobservable value Z^{m}(t) into each equation of state.

The state prediction unit 15 obtains solutions of the equations of state as G control values W^{g}(t) (g=1, . . . , G) (step ST4 in FIG. 4).

Here, it is assumed that the observed value X^{j}(t) and the observed value Y^{k}(t) used by the state prediction unit 15 to calculate the control value W^{g}(t) are the same as the observed value X^{j}(t) and the observed value Y^{k}(t), respectively, which are used when the unobservable value acquiring unit 13 acquires the unobservable value Z^{m}(t) and the like. However, this is merely an example, and the observed value X^{j}(t) and the observed value Y^{k}(t) used by the state prediction unit 15 to calculate the control value W^{g}(t) may be different from the observed value X^{j}(t) and the observed value Y^{k}(t), respectively, which are used when the unobservable value acquiring unit 13 acquires the unobservable value Z^{m}(t) and the like.

That is, the observed value X^{j}(t) used by the state prediction unit 15 is only required to be an observed value of the sensor 2-n and may be an observed value other than the room temperature. If X^{j}(t) is an observed value other than the room temperature, X^{j}(t+1) is an observation predicted value other than the room temperature.

In addition, the observed value Y^{k}(t) used by the state prediction unit 15 is only required to be an observed value of the sensor 2-n and may be an observed value other than the number of people.

When calculating G future control values W^{g}(t+q) (g=1, . . . , G; q=1, . . . , Q) in the air conditioner 1, the state prediction unit 15 substitutes the observed value X^{j}(t;q) of the room temperature, the observed value Y^{k}(t+q) of the number of people, the observation predicted value X^{j}(t+q+1), and the unobservable value Z^{m}(t+q) into each equation of state.

The state prediction unit 15 obtains solutions of the equations of state as G control values W^{g}(t+q) (g=1, . . . , G) at a time t+q (step ST4 in FIG. 4).

The state prediction unit 15 outputs, to the control value selecting unit 16, control values W^{g}(t), W^{g}(t+1), . . . , W^{g}(t+Q) at a plurality of times from the present to the future for each of the control methods as scheduling data D_{c} (c=1, . . . , C) of control values for the control methods.

$${D}_{c} = {W}^{g} ( t ) , {W}^{g} ( t + 1 ) , … , {W}^{g} ( t + Q ) \qquad ( 2 )$$

The control value selecting unit 16 acquires the scheduling data Di to D_{c} for C control methods from the state prediction unit 15.

The control value selecting unit 16 selects the scheduling data D_{c} for any one of the control methods among the scheduling data Di to D_{c} for the C control methods.

That is, the control value selecting unit 16 selects the control values W^{g}(t), W^{g}(t+1), . . . , W^{g}(t+Q) for any one of the control methods (step ST5 in FIG. 4).

Specifically, the control value selecting unit 16 compares predicted errors of the observation predicted value X^{j}(t) used when calculating the control value W^{g}(t−1) by each of the C control methods with each other.

That is, the control value selecting unit 16 compares the predicted errors of C observation predicted values X^{j}(t) acquired at the time (t−1) with each other. The predicted error of the observation predicted value X^{j}(t) is a difference between the observation predicted value X^{j}(t) and the observed value X^{j}(t) acquired at a time t.

The control value selecting unit 16 selects control values W^{g}(t), W^{g}(t+1), . . . , W^{g}(t+Q) with the smallest prediction error of the observation predicted value X^{j}(t) among the control values W^{g}(t), W^{g}(t+1), . . . , W^{g}(t+Q) for C control methods.

The control value selecting unit 16 outputs the selected control values W^{g}(t), W^{g}(t+1), . . . , W^{g}(t+Q) to each of the air conditioner 1 and the display data generating unit 17.

The air conditioner 1 acquires the control values W^{g}(t), W^{g}(t+1), . . . , W^{g}(t+Q) from the control value selecting unit 16 of the control value calculating unit 14.

The air conditioner 1 operates based on the control value W^{g}(t) at the time t. The air conditioner 1 operates based on the control value W^{g}(t+q) at a time t+q (q=1, . . . , Q).

The display data generating unit 17 acquires each of the observed value X^{j}(t) (j=1, . . . , J) of the room temperature and the observed value Y^{k}(t) (k=1, . . . , K) of the number of people from the observed value acquiring unit 11.

In addition, the display data generating unit 17 acquires the observation predicted value X^{j}(t+q) (q=1, . . . , Q) from the observation predicted value acquiring unit 12.

The display data generating unit 17 acquires, from the unobservable value acquiring unit 13, each of the current unobservable value Z^{m}(t) and the future unobservable value Z^{m}(t+q) (g=1, . . . , G; q=1, . . . , Q).

In addition, the display data generating unit 17 acquires the control values W^{g}(t) and W^{g}(t+q) (g=1, . . . , G) from the control value selecting unit 16.

The display data generating unit 17 generates display data for displaying one or more of the unobservable value Z^{m}(t) and the control values W^{g}(t), W^{g}(t+1), . . . , W^{g}(t+Q) (step ST6 in FIG. 4).

In addition, the display data generating unit 17 generates display data for displaying one or more of the observed value X^{j}(t) of the room temperature, the observed value Y^{k}(t) of the number of people, and the observation predicted value X^{j}(t+1) (step ST6 in FIG. 4). Since the display data generating processing itself is a known technique, detailed description thereof is omitted.

The display data generating unit 17 outputs the generated display data to the display device 4.

The display device 4 displays the observed value X^{j}(t) of the room temperature, the observed value Y^{k}(t) of the number of people, the observation predicted value X^{j}(t+1), the unobservable value Z^{m}(t), or the control values W^{g}(t), W^{g}(t+1), . . . , W^{g}(t+Q) on the display based on the display data output from the display data generating unit 17.

In the first embodiment described above, the apparatus control device 3 is configured to include the observed value acquiring unit 11 that acquires, from the sensor 2-n (n=1, . . . , N) that observes the environment in which the control target apparatus is installed, the observed value of the environment, the observation predicted value acquiring unit 12 that gives the observed value acquired by the observed value acquiring unit 11 to the first learning model 12a and acquires the observation predicted value that is the future observed value from the sensor 2-n from the first learning model 12a, and the unobservable value acquiring unit 13 that gives the observed value acquired by the observed value acquiring unit 11 to the second learning model 13a and acquires the unobservable value that is a value not directly observed by the sensor 2-n from the second learning model 13a. In addition, the apparatus control device 3 includes the control value calculating unit 14 that calculates the control value of the control target apparatus using the observed value acquired by the observed value acquiring unit 11, the observation predicted value acquired by the observation predicted value acquiring unit 12, and the unobservable value acquired by the unobservable value acquiring unit 13. Therefore, the apparatus control device 3 can acquire a control value that changes depending on the unobservable value that is a value not directly observed by the sensor 2-n.

In the apparatus control device 3 illustrated in FIG. 1, the state prediction unit 15 obtains the solution of the equation of state on the assumption that each of the parameters P₁ⱼ, P₂ₖ, and P_{3g} included in the equation of state is a default value. However, this is merely an example, and the state prediction unit 15 may determine each of the parameters P₁ⱼ, P₂ₖ, and P_{3g} as follows.

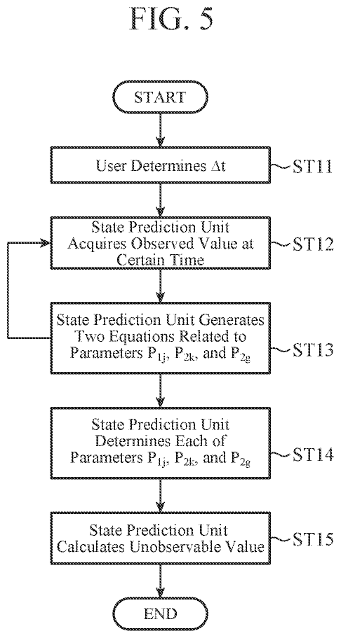

FIG. 5 is a flowchart illustrating processing contents of the state prediction unit 15.

First, a user determines Δt that satisfies the following Equation (3) (step ST11 in FIG. 5).

$${Z}^{m} ( t + Δ t ) - {Z}^{m} ( t ) = 0 \qquad ( 3 )$$

The state prediction unit 15 acquires observed values X^{j}(tₕ−Δt), X^{j}(tₕ), and X^{j}(tₙ+Δt) at certain times tₕ−Δt, tₕ, tₕ+Δt from the observed value acquiring unit 11 (step ST12 in FIG. 5).

Assuming that dX/dt is the right hand side of the following Equation (4), the state prediction unit 15 generates two equations related to the parameters P₁ⱼ, P₂ₖ, and P_{3g} included in the equation of state shown in Equation (1) (step ST13 in FIG. 5). The two equations include, for example, an equation obtained by subtracting the equation of state shown in Equation (1) when the time t is the time tₕ from the equation of state shown in Equation (1) when the time t is the time tₕ−Δt, and an equation obtained by subtracting the equation of state shown in Equation (1) when the time t is the time tₕ+Δt from the equation of state shown in Equation (1) when the time t is the time tₕ.

$$\frac{d X}{d t} = \frac{X ( {t}_{h} + Δ t ) - X ( {t}_{h} )}{Δ t} \qquad ( 4 )$$

The state prediction unit 15 obtains two equations at different times by repeating the processing of steps ST12 and ST13 a specified number of times.

The state prediction unit 15 determines each of the parameters P₁ⱼ, P₂ₖ, and P_{3g} on the basis of the two equations at different times (step ST14 in FIG. 5).

The state prediction unit 15 calculates an unobservable value Z^{m}(t) on the basis of the parameters P₁ⱼ, P₂ₖ, and P_{3g} (step ST15 in FIG. 5).

Here, the state prediction unit 15 determines each of the parameters P₁ⱼ, P₂ₖ, and P_{3g}, and calculates the unobservable value Z^{m}(t) on the basis of the parameters P₁ⱼ, P₂ₖ, and P_{3g}. However, this is merely an example, and the state prediction unit 15 may simply determine each of the parameters P₁ⱼ, P₂ₖ, and P_{3g} and output the unobservable value Z^{m}(t) from the unobservable value acquiring unit 13.

The unobservable value Z^{m}(t) based on the parameters P₁ⱼ, P₂ₖ, and P_{3g} can be obtained by the state prediction unit 15 performing a simulation, for example.

### Second Embodiment

In a second embodiment, an apparatus control device 3 in which a control value calculating unit 18 includes a control value receiving unit 19 that receives a control value of a control target apparatus from the outside of the unit will be described.

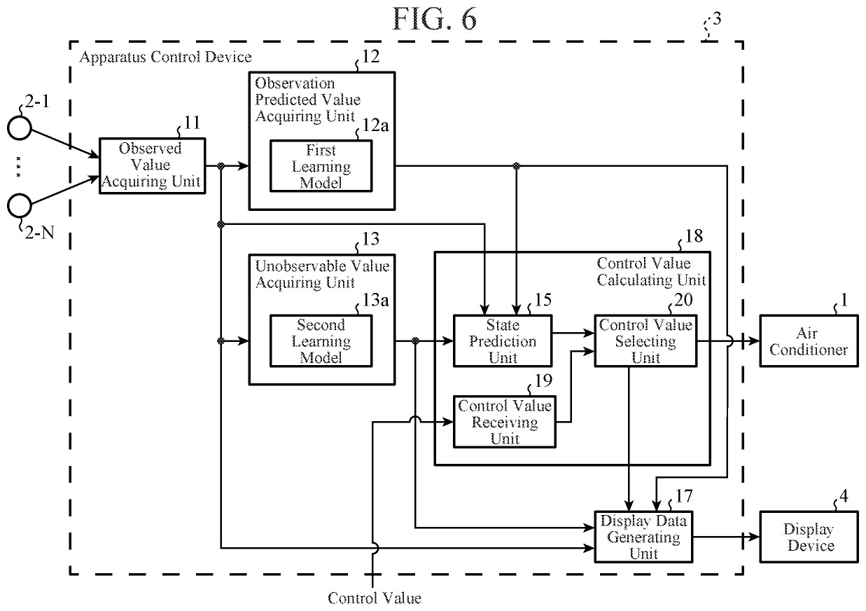

FIG. 6 is a configuration diagram illustrating an apparatus control system including the apparatus control device 3 according to the second embodiment. In FIG. 6, the same reference numerals as those in FIG. 1 denote the same or corresponding parts, and thus description thereof is omitted.

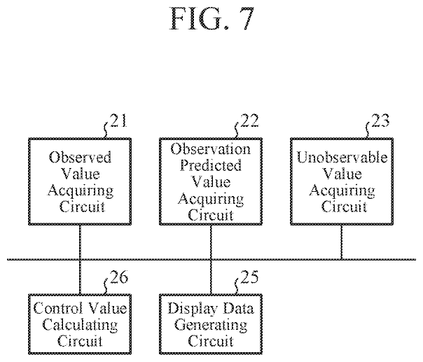

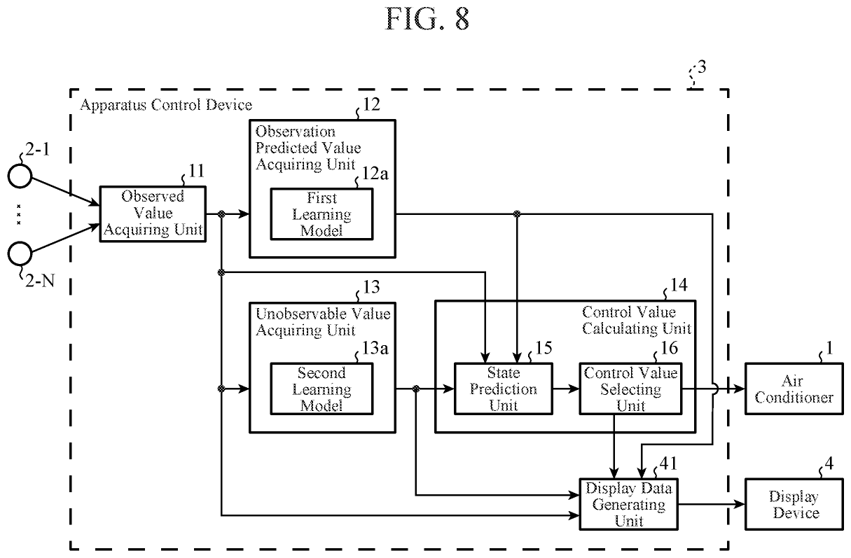

FIG. 7 is a hardware configuration diagram illustrating hardware of the apparatus control device 3 according to the second embodiment. In FIG. 7, the same reference numerals as those in FIG. 2 denote the same or corresponding parts, and thus description thereof is omitted.

The control value calculating unit 18 is implemented by, for example, a control value calculating circuit 26 illustrated in FIG. 7.

The control value calculating unit 18 includes a state prediction unit 15, the control value receiving unit 19, and a control value selecting unit 20.

The control value receiving unit 19 receives control values W(t)′ and W(t+q)′ of an air conditioner 1 from the outside of the unit, and outputs control values W(t)′, W(t+1)′, . . . , W(t+Q)′ to the control value selecting unit 20.

The control value selecting unit 20 acquires control values W^{g}(t), W^{g}(t+1), . . . , W^{g}(t+Q) for C control methods from the state prediction unit 15, and acquires control values W(t)′, W(t+1)′, . . . , W(t+Q)′ from the control value receiving unit 19.

The control value selecting unit 20 selects any one control value among the control values W^{g}(t), W^{g}(t+1), . . . , W^{g}(t+Q) for C control methods and the control values W(t)′, W(t+1)′, . . . , W(t+Q)′.

The control value selecting unit 20 outputs the selected control value to each of the air conditioner 1 and a display data generating unit 17.

In FIG. 6, it is assumed that each of an observed value acquiring unit 11, an observation predicted value acquiring unit 12, an unobservable value acquiring unit 13, the control value calculating unit 18, and the display data generating unit 17, which are components of the apparatus control device 3, is implemented by dedicated hardware illustrated in FIG. 7. That is, it is assumed that the apparatus control device 3 is implemented by an observed value acquiring circuit 21, an observation predicted value acquiring circuit 22, an unobservable value acquiring circuit 23, the control value calculating circuit 26, and a display data generating circuit 25.

Each of the observed value acquiring circuit 21, the observation predicted value acquiring circuit 22, the unobservable value acquiring circuit 23, the control value calculating circuit 26, and the display data generating circuit 25 corresponds to, for example, a single circuit, a composite circuit, a programmed processor, a parallel programmed processor, ASIC, FPGA, or a combination thereof.

The components of the apparatus control device 3 are not limited to those implemented by dedicated hardware, and the apparatus control device 3 may be implemented by software, firmware, or a combination of software and firmware.

In a case where the apparatus control device 3 is implemented by software, firmware, or the like, a program for causing a computer to execute each processing procedure in each of the observed value acquiring unit 11, the observation predicted value acquiring unit 12, the unobservable value acquiring unit 13, the control value calculating unit 18, and the display data generating unit 17 is stored in the memory 31 illustrated in FIG. 3. Then, the processor 32 illustrated in FIG. 3 executes the program stored in the memory 31.

In addition, FIG. 7 illustrates an example in which each of the components of the apparatus control device 3 is implemented by dedicated hardware, and FIG. 3 illustrates an example in which the apparatus control device 3 is implemented by software, firmware, or the like. However, this is merely an example, and some components in the apparatus control device 3 may be implemented by dedicated hardware, and the remaining components may be implemented by software, firmware, or the like.

Next, an operation of the apparatus control system illustrated in FIG. 6 will be described.

A user uses, for example, a man-machine interface (not illustrated) to perform an operation of giving control values W(t)′, W(t+1)′, . . . , W(t+Q)′ of the air conditioner 1 to the apparatus control device 3. The man-machine interface is, for example, a mouse or a keyboard.

The control value receiving unit 19 of the apparatus control device 3 receives the control values W(t)′, W(t+1)′, . . . , W(t+Q)′ of the air conditioner 1 output from the man-machine interface, and outputs the control values W(t)′, W(t+1)′, . . . , W(t+Q)′ to the control value selecting unit 20.

In the apparatus control system illustrated in FIG. 6, the control value receiving unit 19 receives the control values W(t)′, W(t+1)′, . . . , W(t+Q)′ from the man-machine interface. However, this is merely an example, and the control value receiving unit 19 may receive the control values W(t)′, W(t+1)′, . . . , W(t+Q)′ transmitted from a communication device (not illustrated), for example.

The control value selecting unit 20 acquires control values W^{g}(t), W^{g}(t+1), . . . , W^{g}(t+Q) for C control methods from the state prediction unit 15, and acquires control values W(t)′, W(t+1)′, . . . , W(t+Q)′ from the control value receiving unit 19.

The control value selecting unit 20 selects any one control value among the control values W^{g}(t), W^{g}(t+1), . . . , W^{g}(t+Q) for C control methods and the control values W(t)′, W(t+1)′, . . . , W(t+Q)′.

For example, the control value selecting unit 20 compares the predicted error of the observation predicted value X^{j}(t) used when the control value W^{g}(t−1) is calculated by each of the C control methods with the predicted error of the observation predicted value X^{j}(t) when the control value W(t−1)′ is used. That is, the control value selecting unit 20 compares (C+1) predicted errors with each other.

The control value selecting unit 20 selects a control value with the smallest predicted error among the control values W^{g}(t), W^{g}(t+1), . . . , W^{g}(t+Q) for C control methods and the control values W(t)′, W(t+1)′, . . . , W(t+Q)′.

The control value selecting unit 20 outputs the selected control value to each of the air conditioner 1 and the display data generating unit 17.

In the second embodiment described above, the apparatus control device 3 illustrated in FIG. 6 is configured that the control value calculating unit 18 includes the control value receiving unit 19 that receives the control value of the control target apparatus from the outside of the unit, and the control value selecting unit 20 selects any one control value among a plurality of control values calculated by the state prediction unit 15 and the control values received by the control value receiving unit 19. Therefore, like the apparatus control device 3 illustrated in FIG. 1, the apparatus control device 3 illustrated in FIG. 6 can acquire a control value that changes depending on an unobservable value that is a value not directly observed by the sensor 2-n, and can also acquire a control value provided from the outside of the device as the control value of the control target apparatus.

### Third Embodiment

In a third embodiment, an apparatus control device 3 will be described in which a display data generating unit 41 stores an observation predicted value acquired by an observation predicted value acquiring unit 12, and generates display data for displaying information indicating that a difference is larger than a threshold when the difference between the stored observation predicted value and the observed value acquired by an observed value acquiring unit 11 is larger than the threshold.

FIG. 8 is a configuration diagram illustrating an apparatus control system including the apparatus control device 3 according to the third embodiment. In FIG. 8, the same reference numerals as those in FIGS. 1 and 6 denote the same or corresponding parts, and thus description thereof is omitted.

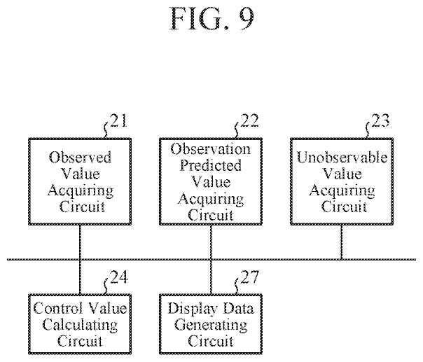

FIG. 9 is a hardware configuration diagram illustrating hardware of the apparatus control device 3 according to the third embodiment. In FIG. 9, the same reference numerals as those in FIGS. 2 and 7 denote the same or corresponding parts, and thus description thereof is omitted.

The display data generating unit 41 is implemented by, for example, a display data generating circuit 27 illustrated in FIG. 9.

Like the display data generating unit 17 illustrated in FIG. 1, the display data generating unit 41 generates display data for displaying an unobservable value acquired by an unobservable value acquiring unit 13 and a control value calculated by a control value calculating unit 14, and outputs the display data to a display device 4.

In addition, like the display data generating unit 17 illustrated in FIG. 1, the display data generating unit 41 generates display data for displaying the observed value acquired by the observed value acquiring unit 11 and the observation predicted value acquired by the observation predicted value acquiring unit 12, and outputs the display data to the display device 4.

Unlike the display data generating unit 17 illustrated in FIG. 1, the display data generating unit 41 stores an observation predicted value X^{j}(t) acquired at a time (t−1) by the observation predicted value acquiring unit 12.

The display data generating unit 41 calculates a difference ΔX^{j}(t) between the stored observation predicted value X^{j}(t) and the observed value X^{j}(t) acquired by the observed value acquiring unit 11.

When the difference ΔX^{j}(t) is larger than a threshold Th, the display data generating unit 41 generates display data for displaying information indicating that the difference ΔX^{j}(t) is larger than the threshold Th, and outputs the display data to the display device 4. The threshold Th may be stored in an internal memory of the display data generating unit 41 or may be provided from the outside of the apparatus control device 3.

In the apparatus control device 3 illustrated in FIG. 8, the display data generating unit 41 is used in the apparatus control device 3 illustrated in FIG. 1. However, this is merely an example, and the display data generating unit 41 may be used in the apparatus control device 3 illustrated in FIG. 6.

In FIG. 8, it is assumed that each of the observed value acquiring unit 11, the observation predicted value acquiring unit 12, the unobservable value acquiring unit 13, the control value calculating unit 14, and the display data generating unit 41, which are components of the apparatus control device 3, is implemented by dedicated hardware illustrated in FIG. 9. That is, it is assumed that the apparatus control device 3 is implemented by an observed value acquiring circuit 21, an observation predicted value acquiring circuit 22, an unobservable value acquiring circuit 23, a control value calculating circuit 24, and the display data generating circuit 27.

Each of the observed value acquiring circuit 21, the observation predicted value acquiring circuit 22, the unobservable value acquiring circuit 23, the control value calculating circuit 24, and the display data generating circuit 27 corresponds to, for example, a single circuit, a composite circuit, a programmed processor, a parallel programmed processor, ASIC, FPGA, or a combination thereof.

The components of the apparatus control device 3 are not limited to those implemented by dedicated hardware, and the apparatus control device 3 may be implemented by software, firmware, or a combination of software and firmware.

In a case where the apparatus control device 3 is implemented by software, firmware, or the like, a program for causing a computer to execute each processing procedure in each of the observed value acquiring unit 11, the observation predicted value acquiring unit 12, the unobservable value acquiring unit 13, the control value calculating unit 14, and the display data generating unit 41 is stored in the memory 31 illustrated in FIG. 3. Then, the processor 32 illustrated in FIG. 3 executes the program stored in the memory 31.

In addition, FIG. 9 illustrates an example in which each of the components of the apparatus control device 3 is implemented by dedicated hardware, and FIG. 3 illustrates an example in which the apparatus control device 3 is implemented by software, firmware, or the like. However, this is merely an example, and some components in the apparatus control device 3 may be implemented by dedicated hardware, and the remaining components may be implemented by software, firmware, or the like.

Next, an operation of the apparatus control system illustrated in FIG. 8 will be described. Here, the apparatus control system is similar to the apparatus control system illustrated in FIG. 1 except for the display data generating unit 41, and thus, an operation of the display data generating unit 41 will be mainly described here.

The display data generating unit 41 acquires the observation predicted value X^{j}(t) acquired at the time (t−1) by the observation predicted value acquiring unit 12, and stores the observation predicted value X^{j}(t).

The display data generating unit 41 acquires the observed value X^{j}(t) from the observed value acquiring unit 11.

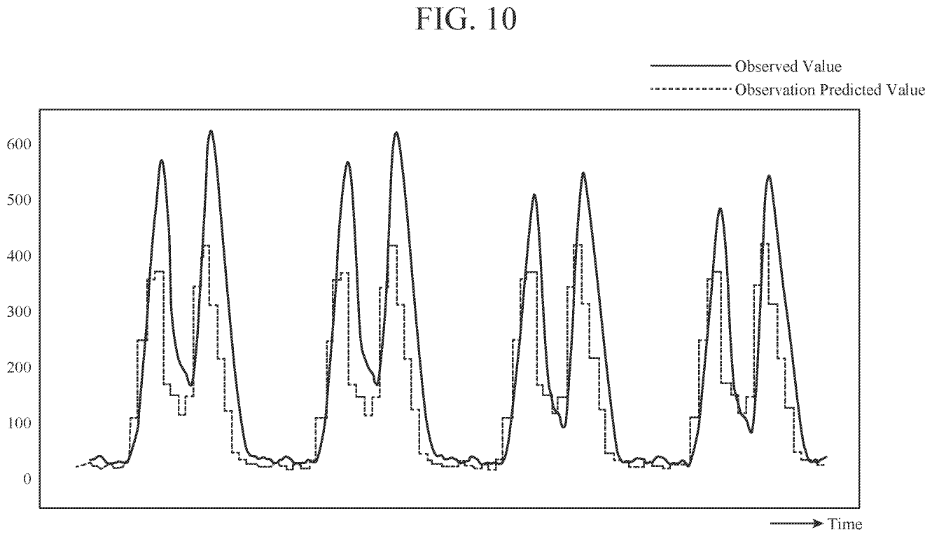

FIG. 10 is an explanatory diagram illustrating the observation predicted value X^{j}(t) and the observed value X^{j}(t) acquired at the time (t−1).

In FIG. 10, the horizontal axis represents time, and the vertical axis represents the magnitude of each of the observation predicted value X^{j}(t) and the observed value X^{j}(t).

A solid line indicates the observed value X^{j}(t), and a broken line indicates the observation predicted value X^{j}(t).

The display data generating unit 41 calculates a difference ΔX^{j}(t) between the stored observation predicted value X^{j}(t) and the observed value X^{j}(t) as represented by the following equation (5).

$$Δ {X}^{j} ( t ) = \vert observation predicted value {X}^{j} ( t ) - observed value {X}^{j} ( t ) \vert \qquad ( 5 )$$

The display data generating unit 41 compares the difference ΔX^{j}(t) with the threshold Th.

When the difference ΔX^{j}(t) is larger than the threshold Th, the display data generating unit 41 generates display data for displaying information indicating that the difference ΔX^{j}(t) is larger than the threshold Th, and outputs the display data to the display device 4.

The display device 4 causes a display to display information indicating that the difference ΔX^{j}(t) is larger than the threshold Th based on the display data. A user viewing the information displayed on the display can recognize that the predicted error is large.

In the apparatus control system illustrated in FIG. 8, the display data generating unit 41 generates the display data for displaying the information indicating that the difference ΔX^{j}(t) is larger than the threshold Th. However, this is merely an example, and when the difference ΔX^{j}(t) is larger than the threshold Th, the display data generating unit 41 may generate display data for highlighting at least one of the observed value X(t) or the observation predicted value X^{j}(t).

In addition, when the difference ΔX^{j}(t) is larger than the threshold Th, the display data generating unit 41 may generate display data for highlighting the control value W^{g}(t).

Note that it is possible to freely combine the embodiments, modify any component of each embodiment, or omit any component of each embodiment in the present disclosure.

### INDUSTRIAL APPLICABILITY

The present disclosure is suitable for an apparatus control device and an apparatus control method.

### REFERENCE SIGNS LIST

1: air conditioner, 2-1 to 2-N: sensor, 3: apparatus control device, 4: display device, 11: observed value acquiring unit, 12: observation predicted value acquiring unit, 12a: first learning model, 13: unobservable value acquiring unit, 13a: second learning model, 14, 18: control value calculating unit, 15: state prediction unit, 16, 20: control value selecting unit, 17, 41: display data generating unit, 19: control value receiving unit, 21: observed value acquiring circuit, 22: observation predicted value acquiring circuit, 23: unobservable value acquiring circuit, 24, 26: control value calculating circuit, 25, 27: display data generating circuit, 31: memory, 32: processor

1. An apparatus control device comprising:
a processor; and
a memory storing a program, upon executed by the processor, to perform a process;
to acquire, from a sensor to observe an environment in which a control target apparatus is installed, an observed value of the environment;
to give an observed value acquired to a first learning model and acquire an observation predicted value that is a future observed value from the sensor from the first learning model;
to give an observed value acquired to a second learning model and acquire an unobservable value that is a value not directly observed by the sensor from the second learning model; and
to calculate a control value of the control target apparatus using an observed value acquired, an observation predicted value acquired, and an unobservable value acquired,
wherein
the process includes to, by substituting an observed value acquired, an observation predicted value acquired, and an unobservable value acquired into each of equations of state in each of the plurality of control methods, calculate a control value for each of a plurality of control methods as a control value of the control target apparatus, and
to select a control value for any one of the plurality of control methods among control values for the plurality of control methods calculated.

2. The apparatus control device according to claim 1, wherein
the process gives an observed value acquired to a second learning model and acquires a current unobservable value and a future unobservable value from the second learning model, and
the process calculates, as a control value of the control target apparatus, control values at a plurality of times from present to future using an observed value acquired, an observation predicted value acquired, the current unobservable value, and the future unobservable value.

3. The apparatus control device according to claim 1, wherein the process selects a control value with a minimum predicted error of an observation predicted value acquired among control values for a plurality of control methods calculated.

4. The apparatus control device according to claim 1, wherein
the process includes to receive a control value of the control target apparatus from outside of the apparatus control device, and
the process selects any one control value among control values for a plurality of control methods calculated and a control value received.

5. The apparatus control device according to claim 1, the process further comprising to generate display data for displaying one or more of an unobservable value acquired and a control value calculated.

6. The apparatus control device according to claim 5, wherein the process generates display data for displaying one or more of an observed value acquired and an observation predicted value acquired.

7. The apparatus control device according to claim 6, wherein the process stores an observation predicted value acquired, and when a difference between an observation predicted value stored and an observed value acquired is larger than a threshold, generates display data for displaying information indicating that the difference is larger than the threshold.

8. An apparatus control method comprising:
acquiring, from a sensor to observe an environment in which a control target apparatus is installed, an observed value of the environment;
giving an observed value acquired to a first learning model and acquiring an observation predicted value that is a future observed value from the sensor from the first learning model;
giving an observed value acquired to a second learning model and acquiring an unobservable value that is a value not directly observed by the sensor from the second learning model; and
calculating a control value of the control target apparatus using an observed value acquired, an observation predicted value acquired, and an unobservable value acquired,
further comprising:
by substituting an observed value acquired, an observation predicted value acquired, and an unobservable value acquired into each of equations of state in each of the plurality of control methods, calculating a control value for each of a plurality of control methods as a control value of the control target apparatus, and
selecting a control value for any one of the plurality of control methods among control values for the plurality of control methods calculated.
